(19) United States
(12) Patent Application Publication
(10) Pub. No.: US 2016/0335609 A1
(43) Pub. Date: Nov. 17, 2016

(54) REPRESENTATION OF DIGITAL ASSET STRUCTURE, OWNERSHIP AND EVOLUTION BY VIRTUE OF A HIERARCHICAL, COMPOUNDING TAGGING MECHANISM ON A TRANSACTION-BASED NETWORK

(71) Applicant: Gareth Jenkins, New York, NY (US)

(72) Inventor: Gareth Jenkins, New York, NY (US)

(21) Appl. No.: 15/153,395

(22) Filed: May 12, 2016

Related U.S. Application Data
(60) Provisional application No. 62/162,473, filed on May 15, 2015.

(51) Int. Cl. G06Q 20/06; G06Q 20/38

(52) U.S. Cl. CPC G06Q 20/0655; G06Q 20/3829

(57) ABSTRACT

A system and method for verifying ownership of a digital asset transferred over a network includes creating a first public digital tag for the digital asset upon performing a first transaction, the first digital tag including a unique identifier of the digital asset, a namespace associated with the digital asset, and a first current forward address for the transfer of the digital asset, permanently associating the first public digital tag with the digital asset, and transferring the digital asset with the associated first public digital tag in accordance with the first transaction. A second public digital tag is permanently associated with the digital asset upon a subsequent transfer of the digital asset to a second current forward address in accordance with a second transaction, the second digital tag including the unique identifier of the digital asset, the namespace associated with the digital asset, and a second current forward address for the subsequent transfer of the digital asset.

### RELATED APPLICATIONS

The present invention is a nonprovisional application of U.S. Patent Application No. 62/162,473, filed on May 15, 2015. All descriptions, drawings and teachings set forth therein are expressly incorporated by reference and a claim of priority upon its teachings is expressly made herein.

### FIELD OF THE INVENTION

The present invention relates generally to the public representation and management of structured data related to digital assets on a distributed network using privately controlled namespaces.

### BACKGROUND

Due to the nature of digital systems, digital assets (e.g., tokens, media, files and other structures) are, generally, easily duplicated, copied and exchanged without a loss of fidelity or a record of said duplication or exchange. In addition, in such situations, it is not possible to measure supply or production of such digital items.

As users, including consumers, businesses and software systems, move toward digital rather than physical ownership of assets, they seek a means to verify supply, authenticity and origin of the assets. In some systems, such as those representing partial ownership where unique digital assets carry more utility than duplications or permission and access systems, it is vital to have a means of proving the origin and authenticity of the assets.

Existing technologies and services that attempt to solve the problems of origin and authenticity of digital objects generally rely on systems of centralized trust or third-party verification. Such systems are prone to exploitation and are vulnerable to the availability of the commercial, technical, or legal systems; they do, however, allow for expressive and purpose-specific data structures, features and general utility.

In contrast, a distributed ledger provides a decentralized means to record transactions on a peer-to-peer network, which is managed and supported by its users. “Transactions” on such a network are verified by participating members and cryptographically signed in such a manner than they can be verified as legitimate. The ledger itself is effectively a shared dataset that represents an accumulating set of transactions, allowing for external inspection and auditing by interested parties.

Public/private key cryptography is a means of providing a signing mechanism for data whereby a user can express ownership or “signing” of a set of data with a public key without revealing his private key. Used in combination with a distributed network, public/private key cryptography provides a means of signing transactions such that anybody can verify the “spending” of an output on the network, but only its owner can sign those transactions.

Existing distributed network technologies generally rely on a certain level of utilization to become relevant. One such technology, Bitcoin, has accomplished this by providing both a payments-network solution and general purpose blockchain, namely its distributed ledger. Although Bitcoin transactions that spend the embedded “Bitcoin” currency provide authenticity and external verifiability, they do not provide a means to represent complicated data structures and are generally considered fungible. The Bitcoin transactions therefore only provide a means to verify that a user owns a certain amount of Bitcoin and how they came to own it, but they do not provide information as to what that Bitcoin might represent.

The present invention provides a system for representing ownership, transformations, and hierarchies of digital assets in addition to a public ledger.

### SUMMARY

It is an object of the present invention to provide a method of verifying ownership of a digital asset transferred over a network.

In general, in one aspect, the invention features a method of verifying ownership of a digital asset transferred over a network. A first public digital tag is created for the digital asset upon performing a first transaction, the first digital tag comprising a unique identifier of the digital asset, a namespace associated with the digital asset, and a first current forward address for the transfer of the digital asset. The first public digital tag is permanently associated with the digital asset. The digital asset with the associated first public digital tag is transferred in accordance with the first transaction.

Implementations of the invention may include one or more of the following features. A second public digital tag may be permanently associated with the digital asset upon a subsequent transfer of the digital asset to a second current forward address in accordance with a second transaction, the second digital tag comprising the unique identifier of the digital asset, the namespace associated with the digital asset, and a second current forward address for the subsequent transfer of the digital asset. A tag history may be provided listing the public digital tags permanently associated with the digital asset.

A first validity period may be associated with the first public digital tag to provide a limited time for valid ownership of the digital asset at the first current forward address. A second validity period may be associated with the second public digital tag to provide a limited time for valid ownership of the digital asset at the second current forward address. The first transaction may be signed with a first key associated with the namespace for valid ownership of the digital asset at the first current forward address. The second transaction may be signed with a second key associated with the namespace for valid ownership of the digital asset at the second current forward address.

The first key or the second key is a private key or an application programming interface key. The namespace may include an authority address. The first transaction or the second transaction may be managed by the authority address. The validity of the first transaction may be determined by examining the first public digital tag, and the validity of the second transaction may be determined by examining the second public digital tag. The first public digital tag may be queried. The digital asset may be a token, media, a file, an inventory item or piece of equipment used in a digital video game, a digital representation of a physical item, a digital playing card or digital artwork

In general, in another aspect, the invention features a system for verifying ownership of a digital asset over a network. A first computer is connected to the network for storing the digital asset. A second computer is connected to the network for receiving the digital asset by a transaction transferring the digital asset between the first computer and the second computer, the second computer having a first current forward address for the transfer of the digital asset. The first computer creates a first public digital tag for the digital asset permanently associated with the digital asset, the first public digital tag including a unique identifier of the digital asset, a namespace associated with the digital asset, and the first current forward address.

Implementations of the invention may include one or more of the following features. A third computer may be connected to the network for receiving the digital asset by a subsequent transaction transferring the digital asset between the second computer and the third computer, the third computer having a second current forward asset for the subsequent transfer of the digital asset, and the second computer creating a second public digital tag for the digital asset permanently associated with the digital asset, the second public digital tag including a unique identifier of the digital asset, a namespace associated with the digital asset, and the second current forward address. A fourth computer may be associated with the namespace and has an authority address. The authority address may manage the first transaction or the second transaction. The fourth computer may query the first public digital tag or the second public digital tag over the network. The digital asset may be a token, media, a file, an inventory item or piece of equipment used in a digital video game, a digital representation of a physical item, a digital playing card or digital artwork

In general, in another aspect, the invention features an apparatus including a digital asset transferable over a network and a first public digital tag permanently associated with the digital asset. The first public digital tag includes a unique identifier of the digital asset, a namespace associated with the digital asset, and a first current forward address for transfer of the digital asset. The first public digital tag is created upon performing a first transaction transferring the digital asset to the first current forward address.

Implementations of the invention may include one or more of the following features. A second public digital tag may be permanently associated with the digital asset, the second public digital tag including a unique identifier of the digital asset, a namespace associated with the digital asset, and a second current forward address for transfer of the digital asset, and the second public digital tag being created upon performing a second transaction transferring the digital asset to the second current forward address. The digital asset may be a token, media, a file, an inventory item or piece of equipment used in a digital video game, a digital representation of a physical item, a digital playing card or digital artwork.

### BRIEF DESCRIPTION OF THE DRAWINGS

FIG. 1 shows the tagging of a single address with multiple namespace tags in accordance with an embodiment of the invention;

FIG. 2 shows the creation of the digital asset, tracked with a forward address, in accordance with an embodiment of the invention;

FIG. 3 shows the attaching of multiple tags to a digital asset at different points in its forward address history and lifecycle, in accordance with an embodiment of the invention;

FIG. 4 shows the method for following a digital asset from one address to another and for extracting multiple object transitions from a single network transaction, in accordance with an embodiment of the invention;

FIG. 5 shows the public application programming interface for querying properties of tagged assets and underlying network addresses, in accordance with an embodiment of the invention;

FIG. 6 shows an example of an implementation of bitbind objects to represent verifiable digital art, in accordance with an embodiment of the invention; and

FIG. 7 shows a network for performing transactions transferring digital assets, in accordance with an embodiment of the invention.

### DETAILED DESCRIPTION OF PREFERRED EMBODIMENTS OF THE INVENTION

The present invention provides a system and method for representing ownership of structured digital assets on top of a distributed ledger. It facilitates the independent transfer and inspection of assets or objects 100 by following transactions on the underlying network. Structured data can be represented by hierarchical tags in multiple independent namespaces.

The digital assets referred to herein include tokens, media, files, an inventory item or piece of equipment used in a digital video game, a digital representation of a physical item, a digital playing card or digital artwork.

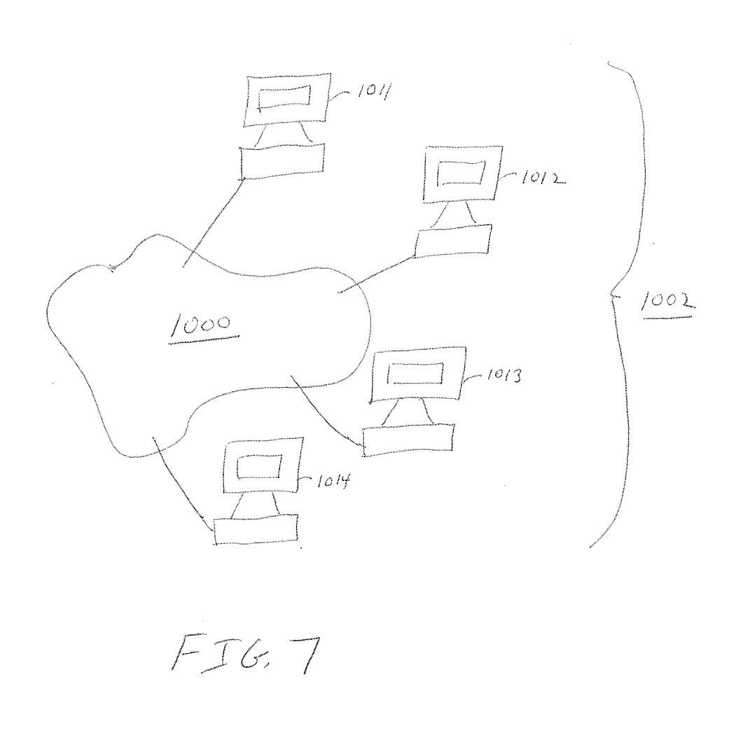

As shown in FIG. 7, the system according to an embodiment of the present invention may be implemented on a network 1000, which may be any wired, wireless or cloud-based distributed network, including the Internet. A series of client devices 1002, e.g., computers, are connected via network 1000. The client devices or computers 1002 may be any computing device, e.g., server or integrated appliance, virtual computer or virtualized network or computing interface, or any desktop computer, tablet, smartphone or the like, with standard components including a central processing unit, storage, an interface with a display and associated input/output devices, and a network interface or communications circuit. The input/output devices may include a touch display, keyboard, mouse and the like. The network interface or communications circuit provides connectivity with network 1000. In connection with an embodiment of the present invention, a digital asset is first transferred from a first computer 1011 to a second computer 1012, and subsequently transferred from the second computer 1012 to a third computer 1013. A fourth computer 1014 may include an authority address to manage a transaction involving the digital asset, or may be used to query public digital tags associated with the digital asset.

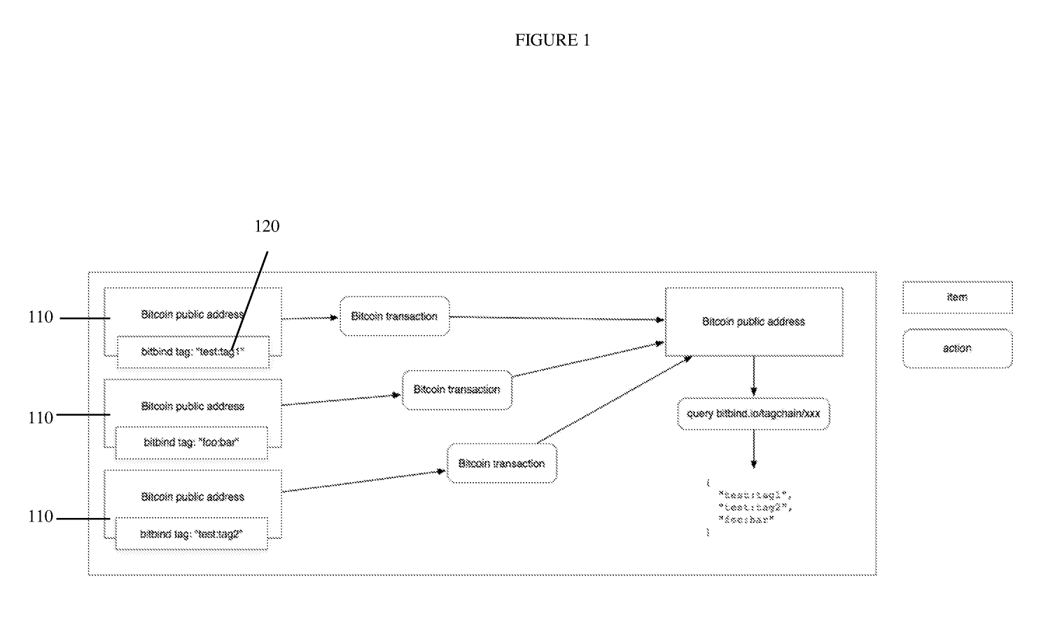

FIG. 1 shows digital tags 110, sometimes herein referred to as bitbind tags, being applied to addresses of, e.g., computers, on the underlying network. The term bitbind refers to a protocol that defines a system of hierarchical, compound digital tags 110 created with privately controlled namespaces 120 on a public distributed ledger, and the creation and management of tracked objects defined by the tags 100 that are stored and transacted on the underlying network (e.g., the Bitcoin blockchain). The bitbind structure also includes a service to query and create the tags 110 and objects 100.

A namespace 120 is a set of symbols, usually a human-readable string of characters, that is used to group and otherwise identify data. The namespace owner of the tag 110 denotes an authority address, and by virtue of the owner also managing the private signing of transactions from that address on the underlying network, he also controls the sole rights to “tag” other addresses with that namespace. Multiple tagged authority addresses can send transactions to a single destination address, creating a compound list of tags applied to that address. Multiple authority namespace owners can tag single addresses, creating a list of mixed namespace tags at a single address.

In one embodiment, all tags 100 are prefixed with the owner's root namespace 120, meaning multiple namespace owners can have similar, but not conflicting, tag hierarchies. For example, a namespace owner “owner” can have a tag “exampletag,” and a resulting tagged address would return “owner:exampletag” in its list of tags.

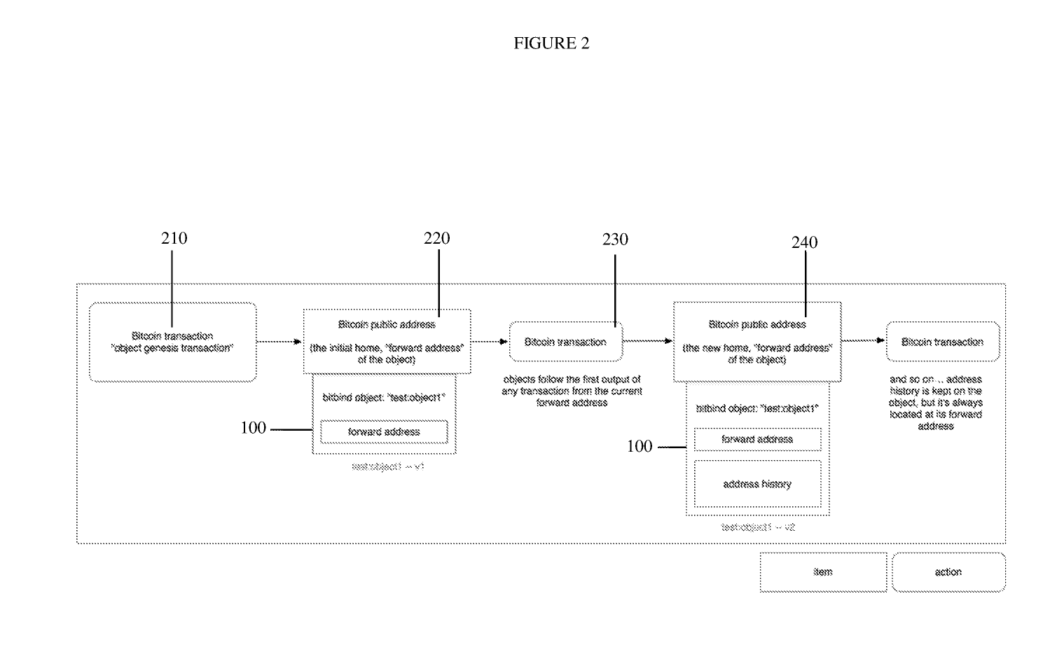

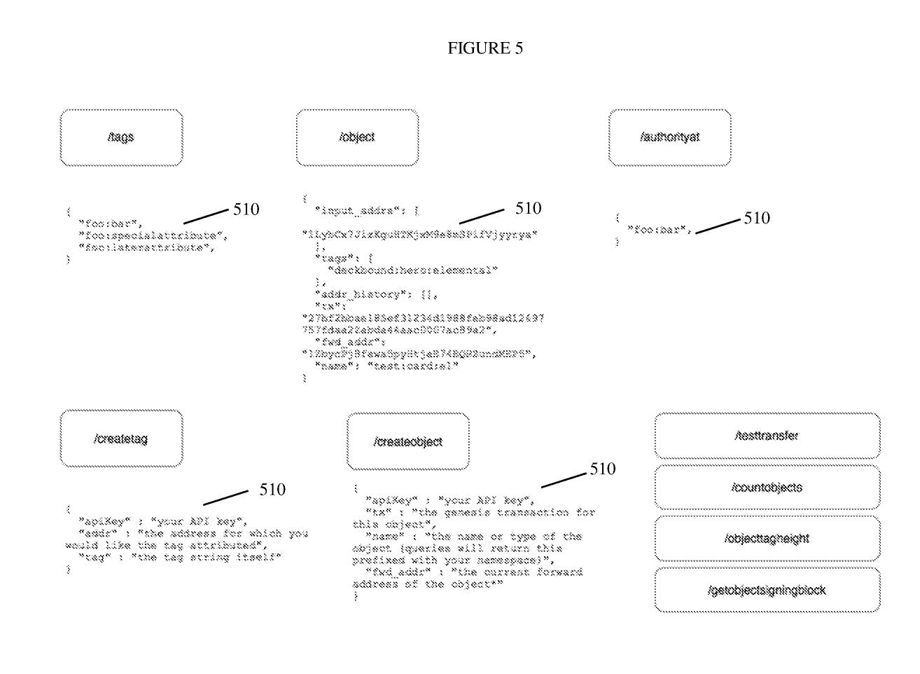

FIG. 2 shows an example of how a digital object is created and tracked using the bitbind tags 100. A single transaction on the underlying network represents the genesis transaction 210 for the object 100, and provides the object's unique identifier. The first output of that transaction is considered the first “forward address” of the object 220. To move the object on the underlying network, the current forward address must participate in a transaction as per a format similar to that of FIG. 5, where the output is the new home of the object. Objects can be moved many times, with the bitbind tagging service following each of the “transfer” transactions to maintain a current forward address. The identity of an object is preferably composed of its genesis transaction and identifier, its history of addresses, its current forward address, and the list of tags applied to the object 100. References herein to transfer of a digital asset include transfer of the digital asset itself and/or transfers of a description of the digital asset.

Because transfer transactions happen on the underlying network, an object transfer can take place between parties where the transferring party need to only know the public address of the receiving party. This is similar to the way raw underlying network transactions take place.

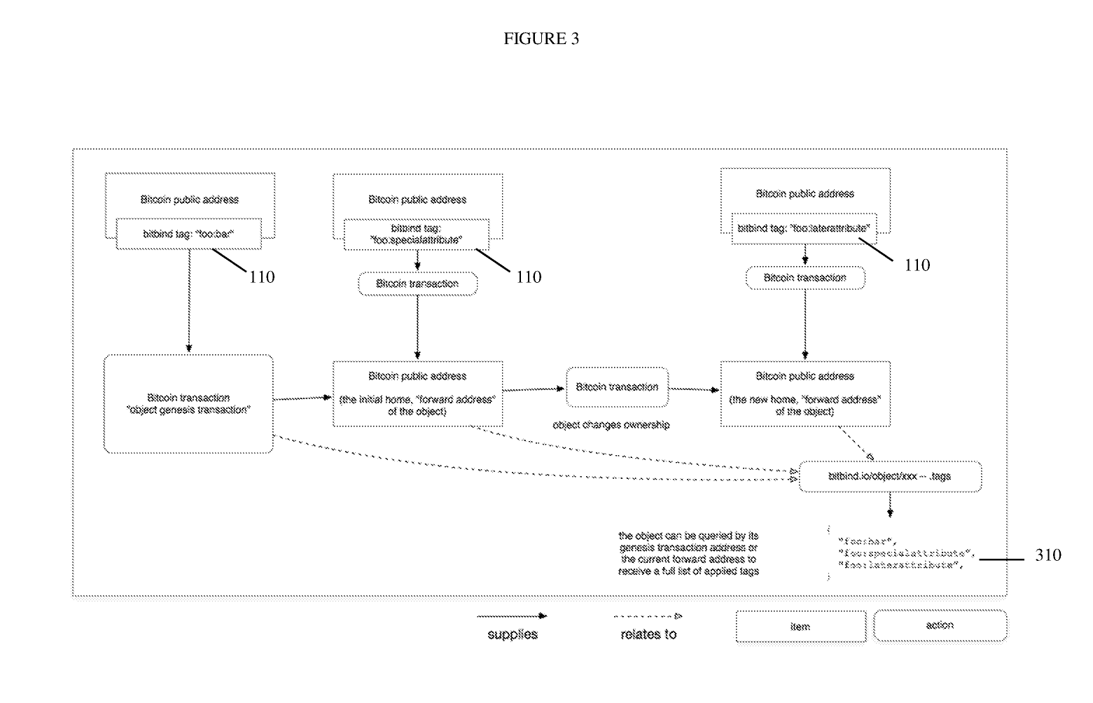

A user can request to view the tags 110 of an object 100. The tags returned from such a request are a list 310 of all tags applied to any contemporary forward address in the history of the underlying network's ledger, as shown in FIG. 3.

FIG. 3 shows an example of multiple tags 110 applied to an object at different times in its forward address history. A tag 110 can only be legitimately applied to the current forward address of an object, but once applied that tag applies for the full life of the object. The list of current tags for an object is the list of tags applied to each of its forward addresses at a time when they were the current forward address. When an object 100 changes ownership, the bitbind system sees that movement in the underlying network and adds the new location of the object to the end of the forward address history. As depicted in FIG. 3, tags can be applied to an object by sending a tagging transaction to the current forward address. A tagging transaction sent to an old forward address, e.g., an address in the forward address history that is not the last one, is not considered a valid tag for the object. It should be noted that reuse of an address may make the address a valid tag for a different object. The culmination of all valid tags applied to an object in its history will always be returned as part of the object 100.

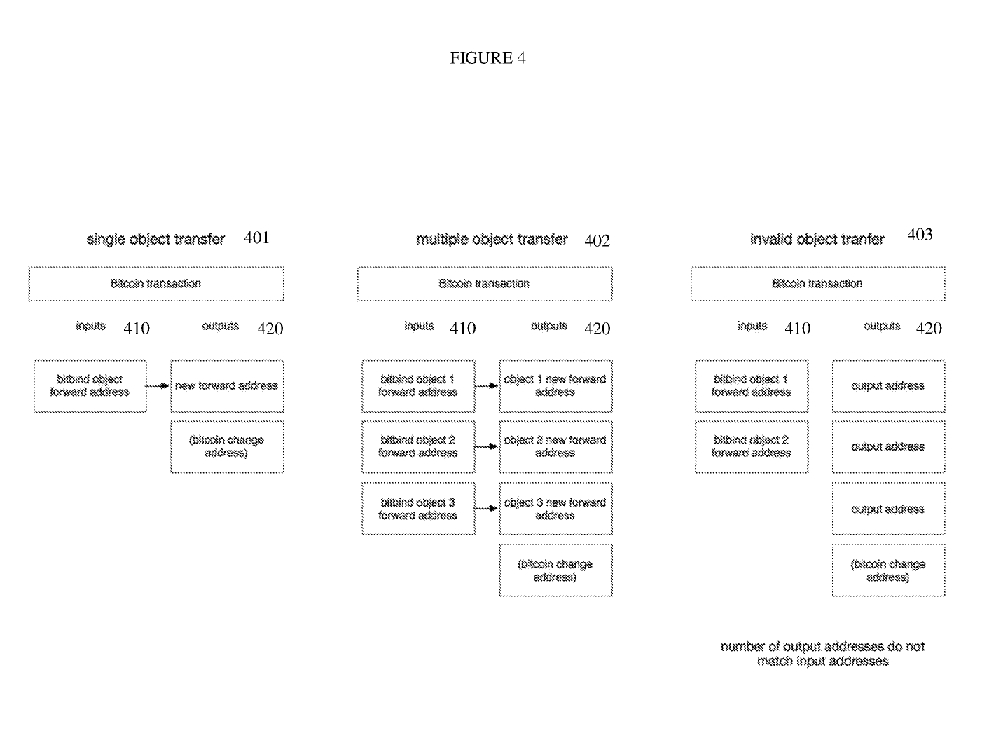

FIG. 4 shows examples of valid and invalid object transfers. For an underlying network transfer to be considered a valid “transfer” transaction in the context of bitbind, but not necessarily the underlying network, it must contain a 1:1 mapping on object inputs 410 to valid output addresses 420, with an additional “change” output in the destinations list. The first example 401 shows a single bitbind object transferring to a new forward address home. The second example 402 shows three separate object transfers; these could be by multiple owning parties, but because the signing of the transaction on the underlying network must consider all private address key owners it is more likely that these would be a single logical “owner.” The third example 403 shows a transaction that is considered invalid because there is not a matching number of outputs 420 to inputs 410. Though the transfer of the third example would be valid on the underlying network (i.e., only valid underlying network transactions are parsed by the bitbind service implementation), it is not considered a valid bitbind object transfer and as such would be ignored in whole (i.e., none of the objects' forward addresses are modified).

FIG. 5 describes examples of external interfaces that may be presented by the bitbind service. “/tag”, “/object” and “/authorityat” are examples of public interfaces that can be queried by any interested party. A query returns a list 510 of tags at an address, a full description of an object, and any created “authority” tags at a specified address, respectively. “/createtag” and “/createobject” are examples of public interfaces that require signing with a private key or known application programming interface key associated with the owner's namespace. The signatures create a tag at an address which would then be reflected by interfaces such as “/authorityat,” or the signatures create an object using a genesis transaction. Although it is possible to have multiple authority tags at an address, there are no means to have them then be applied individually. Further, it is possible for a namespace owner to create the same tag at multiple addresses (i.e., owner “owner” could have the tag “multipleroot” at address A and B, with outputs/tagged addresses from address A and B returning “owner:multipleroot”). It is possible to create an object from the same transaction that is used to tag an address; this could be used to create multiple instances of an object type from a single source. For example, an address with tagging authority “objecttype” could issue a transaction output to a destination address, and a separate call to the “/createobject” interface could use the transaction address of that tagging transaction to create an object that would automatically receive the “owner:objecttype” tag. Users can query the total number of objects tagged with a particular tag by querying interfaces such as the “/countobjects” interface. By supplying multiple tags, inferences can be made about the association between similarly tagged objects. This interface can also be used to provide information about the total number of a particular type of object, allowing for a published and verifiable “scarcity” mechanism for objects. To complement this, there can be queries such as the “/objecttagheight” query that return the effective issue number for a particular tagged object among all similarly tagged objects.

The “/getsigningblock” interface is another example of an interface that is a special-purpose version of “/object” that allows the caller to specify a “validity period.” This is intended to be used in a situation where the user wants to provide a signed (i.e., with the private key that relates to the ownership of the object) version of the public information so that others may verify that the user owns the object in question (i.e., where ownership is manifest by controlling the related private keys). The validity period may be any period of time, expressed in minutes, and provides a user-driven interval over which the user can prove ownership (e.g., “within the last X minutes I have owned this object”).

The bitbind system could be used, for example, to represent ownership of collectible trading cards for use in decentralized games. In such an implementation, each card would be represented by a bitbind object, and the tags applied to that bitbind object by the issuer of the digital cards would represent the type of card. Games implementing play with the card would be able to inspect the bitbind object to verify authenticity of the card as well as query information about how it should be used. Owners of cards would be able to trade them independently of their issuer.

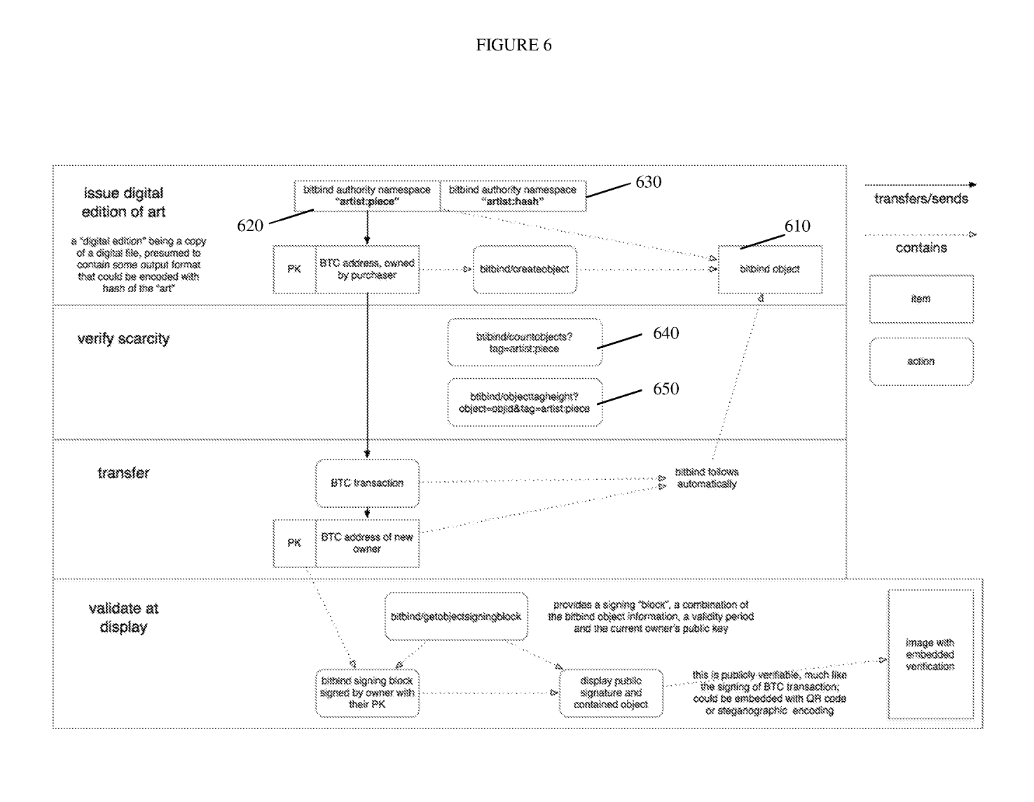

FIG. 6 depicts an example application of bitbind in the issue, transfer, and verification of digital art. An artist would create a bitbind object 610 to represent the digital art using a unique tag 620 for his name and the name of the piece of art, as well as a digital hash 630 of the piece of art. The object 610 would be sent to the owner of the digital art. Many copies could be issued to many owners by similarly tagging multiple bitbind objects. Consumers or interested parties can verify the number of issued items as well as the “issue number” of a particular art item by querying the bitbind utilities “countobjects” 640 and “objecttagatheight” 650. Transfer of ownership would happen in the same way as with other bitbind objects, with a transaction on the underlying network. Digital art could be verified as owned by the party displaying the art by virtue of signing a special “signing block” provided by bitbind about the bitbind object representing that instance of the digital art item. This signing block would include a validity period (e.g., 10 minutes or 4 hours) and would be signed by the owner using the same private key used to manage the object ownership itself. The digital art would be displayed with this embedded signed block (e.g., as a QR code or via a steganographic encoding) and could be verified as being signed by the owner within the relevant time period by any interested party.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed is:

1. A method of verifying ownership of a digital asset transferred over a network, comprising:
creating a first public digital tag for the digital asset upon performing a first transaction, the first digital tag comprising a unique identifier of the digital asset, a namespace associated with the digital asset, and a first current forward address for the transfer of the digital asset;
permanently associating the first public digital tag with the digital asset; and
transferring the digital asset with the associated first public digital tag in accordance with the first transaction.

2. The method of claim 1 wherein a second public digital tag is permanently associated with the digital asset upon a subsequent transfer of the digital asset to a second current forward address in accordance with a second transaction; the second digital tag comprising the unique identifier of the digital asset, the namespace associated with the digital asset, and a second current forward address for the subsequent transfer of the digital asset.

3. The method of claim 2 further comprising providing a tag history listing the public digital tags permanently associated with the digital asset.

4. The method of claim 1 further comprising associating a first validity period with the first public digital tag to provide a limited time for valid ownership of the digital asset at the first current forward address.

5. The method of claim 2 further comprising associating a second validity period with the second public digital tag to provide a limited time for valid ownership of the digital asset at the second current forward address.

6. The method of claim 1 further comprising signing the first transaction with a first key associated with the namespace for valid ownership of the digital asset at the first current forward address.

7. The method of claim 6 wherein the first key is a private key or an application programming interface key.

8. The method of claim 2 further comprising signing the second transaction with a second key associated with the namespace for valid ownership of the digital asset at the second current forward address.

9. The method of claim 8 wherein the second key is a private key or an application programming interface key.

10. The method of claim 1 wherein the namespace comprises an authority address.

11. The method of claim 10 wherein the first transaction is managed by the authority address.

12. The method of claim 2 wherein the namespace comprises an authority address.

13. The method of claim 12 wherein the second transaction is managed by the authority address.

14. The method of claim 1 further comprising determining the validity of the first transaction by examining the first public digital tag.

15. The method of claim 2 further comprising determining the validity of the second transaction by examining the second public digital tag.

16. The method of claim 1 wherein the digital asset is a token, media, a file, an inventory item or piece of equipment used in a digital video game, a digital representation of a physical item, a digital playing card or digital artwork.

17. The method of claim 1 further comprising querying the first public digital tag.

18. A system for verifying ownership of a digital asset over a network, comprising:
a first computer connected to the network for storing the digital asset;
a second computer connected to the network for receiving the digital asset by a transaction transferring the digital asset between the first computer and the second computer, the second computer having a first current forward address for the transfer of the digital asset;
wherein the first computer creates a first public digital tag for the digital asset permanently associated with the digital asset, the first public digital tag comprising a unique identifier of the digital asset, a namespace associated with the digital asset, and the first current forward address.

19. The system of claim 18 further comprising a third computer connected to the network for receiving the digital asset by a subsequent transaction transferring the digital asset between the second computer and the third computer, the third computer having a second current forward asset for the subsequent transfer of the digital asset;
wherein the second computer creates a second public digital tag for the digital asset permanently associated with the digital asset, the second public digital tag comprising a unique identifier of the digital asset, a namespace associated with the digital asset, and the second current forward address.

20. The system of claim 18 further comprising a fourth computer associated with the namespace and having an authority address.

21. The system of claim 20 wherein the authority address manages the first transaction.

22. The system of claim 20 wherein the fourth computer queries the first public digital tag over the network.

23. The system of claim 19 further comprising a fourth computer associated with the namespace and having an authority address.

24. The system of claim 23 wherein the authority address manages the second transaction.

25. The system of claim 23 wherein the fourth computer queries the second public digital tag over the network.

26. The system of claim 18 wherein the digital asset is a token, media, a file, an inventory item or piece of equipment used in a digital video game, a digital representation of a physical item, a digital playing card or digital artwork.

27. An apparatus, comprising:
a digital asset transferable over a network; and
a first public digital tag permanently associated with the digital asset, the first public digital tag comprising a unique identifier of the digital asset, a namespace associated with the digital asset, and a first current forward address for transfer of the digital asset, and the first public digital tag being created upon performing a first transaction transferring the digital asset to the first current forward address.

28. The apparatus of claim 27, comprising:
a second public digital tag permanently associated with the digital asset, the second public digital tag comprising a unique identifier of the digital asset, a namespace associated with the digital asset, and a second current forward address for transfer of the digital asset, and the second public digital tag being created upon performing a second transaction transferring the digital asset to the second current forward address.

29. The apparatus of claim 27 wherein the digital asset is a token, media, a file, an inventory item or piece of equipment used in a digital video game, a digital representation of a physical item, a digital playing card or digital artwork.
